(19) United States
(12) Patent Application Publication
(10) Pub. No.: US 2021/0156591 A1
(43) Pub. Date: May 27, 2021

(54) System Providing Protection from the Cold

(71) Applicant: Dieter Wirsching, Stammheim (DE)

(72) Inventor: Dieter Wirsching, Stammheim (DE)

(21) Appl. No.: 16/622,127

(22) PCT Filed: Jun. 12, 2018
(86) PCT No.: PCT/EP2018/065511

§ 371 Date: Sep. 1, 2020

(30) Foreign Application Priority Data
Jun. 14, 2017 (DE) 10 2017 005 646.3

(51) Int. Cl. F24H 3/10; A47C 7/74; E04H 3/10

(52) U.S. Cl. CPC F24H 3/102; E04H 3/10; A47C 7/748

(57) ABSTRACT

The invention relates to a cryoprotective device comprises a first section, which is a floor section (1) extending in a horizontal direction, and a second section which is a wall section (2) extending away from the floor section (1) substantially in a vertical direction, further comprising a planar heating facility (3A) of the floor section (1) which discharges a heat output to the space (4) delineated in part by the floor section (1) and the wall section (2).

The present invention relates to a cryoprotective device for outdoors, which can in particular be used at sporting events and which protects people against the effects of the cold.

At sporting events, such as for example football games, the athletes who are not currently participating in the game and are on standby as substitute players are seated on a so-called substitutes' bench at the periphery of the pitch, wherein the people waiting on the substitutes' bench to maybe be brought into the game are exposed to cooler temperatures, particularly when sporting events are being held outside, which is not only markedly uncomfortable for said people but is even distinctly counterproductive for their later involvement in the game. In order therefore to protect against hypothermia, multiple items of clothing are worn one over the other in a so-called “layered arrangement”, wherein football players in particular use particularly well-insulating snow boots, so-called “Moon Boots®”, for the feet, which are sensitive, and blankets for the legs, which are susceptible to injury. On the other hand, this prevents them from wearing their actual player's attire and thus necessitates a laborious change of clothes when entering the game.

DE 35 45 862 A1 discloses a housing-like protective device which comprises a bench for people to sit on and which is intended to shield the people sitting in it from any exposure to the elements and thus avoid the risk of illness or even damage to health. Among other things, a heating and air-conditioning facility is provided below the seating area of the bench for this purpose, which discharges heating and/or cooling air into the housing-like protective device. However, warmed heating air is often felt to be unpleasant, in particular when it is blown out, and sometimes causes the affected parts of the body to be non-uniformly warmed, which is likewise felt to be unpleasant.

It is the object of the present invention to provide a cryoprotective device which can be universally and quickly employed and which protects athletes against hypothermia in a pleasant way and significantly reduces the risk of injury during play.

This object is solved by the subject-matter of independent patent claim 1, wherein the sub-claims define preferred embodiments of the present invention.

The present invention provides a cryoprotective device which comprises a first section, which is a floor section extending in a horizontal direction, and a second section which is a wall section extending away from the floor section in a substantially vertical direction, wherein the floor section comprises a planar heating facility which discharges a heat output to the space delineated in part by the floor section and the wall section.

In other words, the present invention provides a heating device which substantially consists of a horizontal segment and a vertical segment, wherein the former functions as it were as a standing area or floor for the people seated on a seating facility, and the latter serves as a wind or even privacy screen disposed in front of the seating facility. The planar heating facility of the horizontal floor section uniformly discharges heat to the space above it across the dimensions of the floor section, thus avoiding the localised warming of parts of the body which is felt to be unpleasant.

In order to increase the heat output, the wall section of the cryoprotective device can also comprise a planar heating facility, like the floor section, which discharges heat in a rearward direction to the people situated there. This means there is also an additional heat input from a different direction, thus even more uniformly warming the parts of the body situated in the space delineated in part by the floor section and the wall section.

In a particularly preferred embodiment, the heat output discharged by the planar heating facility of the floor section and/or wall section is discharged substantially in the form of heat radiation. The heating facility of the floor section and/or wall section can then comprise at least one infrared radiator which discharges infrared radiation in the direction of the space delineated in part by the floor section and the wall section.

The heat inputted to the parts of the body can thus be generated in a pleasant way just below the surface of the skin. This also creates a constant physiological heat in the sensitive region of the players' legs and feet. The permeating heat of the longwave radiation is perceived in a similarly positive way to the warmth of the sun, thus increasing both physical and mental wellbeing.

The wall section which extends substantially in a vertical direction also contributes to this, in that it visually shields the players to a certain extent and, in conjunction with the heating facility, creates a pleasant environment for the players.

The side of the vertical wall section which faces away from the rearward space can be configured to be substantially plane and can thus serve as an advertising space facing the pitch. For this purpose, said front side can also be tilted backwards slightly, such that an advertising slogan attached to it can be viewed by spectators from an angle which is as perpendicular as possible.

In addition, the upper side of the floor section, i.e. the side facing the seated players, can comprise a surface covering, in particular an artificial turf covering, which can withstand being stood on. Matching the standing area to the ground conditions of the pitch environment means that the cryoprotective device in accordance with the invention can also be conveniently entered in the footwear envisaged for involvement in the game.

In a more preferred embodiment, the cryoprotective device in accordance with the invention can be configured to be modularly extendable. It can then be extended at will according to requirement, in order to provide protection from the cold for a desired number of people. For this purpose, it is envisaged that the opposing lateral peripheral regions of the floor section and/or wall section comprise mutually complementary interfaces which enable any two modules to be coupled to each other, wherein the complementary interfaces can be configured such that they respectively engage on one side or also reciprocally, in order for example to bind the individual modules fixedly to each other by means of a positive fit.

A major advantage of the present invention is that the cryoprotective device can be provided as an autonomous device, i.e. one which is not bound to other facilities or installations. It can thus be separately transported and installed. Depending on the weather conditions, the cryoprotective device in accordance with the invention can be quickly erected in front of a substitutes' bench which is already installed anyway, or can equally well remain in situ as a fixed installation and facility complementing the substitutes' bench.

For transport purposes, individual modules of the cryoprotective device can be configured such that they can be stacked one on top of the other, wherein it is in particular regarded as advantageous if the floor section and the wall section are connected to each other detachably and/or in a joint, such that the cryoprotective device can be dismantled, or collapsed in a particularly space-saving way, for transport.

Conversely, the floor section of the cryoprotective device can also comprise a region which is configured for positioning or even fastening a seating facility. In other words, the floor section then extends up to and below the substitutes' bench, in order to bear or at least support it.

The invention is described below in more detail on the basis of a preferred example embodiment and by referring to the enclosed FIGURE. The cryoprotective device in accordance with the invention can comprise the features described below, individually and in any expedient combination.

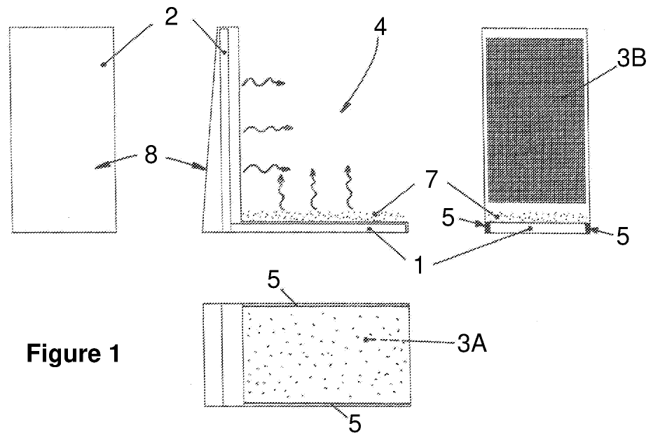

FIG. 1 shows a four-sided view of a module of the cryoprotective device in accordance with the invention. It substantially comprises a horizontally extending floor section 1, the underside of which lies on the ground at the periphery of the pitch and the upper side of which comprises an artificial turf covering 7. In addition, a spatial region 4 situated above the floor section 1 and the artificial turf covering 7 is also delineated by the wall section 2 which extends substantially in a vertical direction. The legs of the people seated on a substitutes' bench (not shown) are at least partially situated within this spatial region 4. In other words, said people are seated on the substitutes' bench in such a way that they place their feet on the floor section 1, while the wall section 2 disposed in front of the players provides a privacy screen.

Both the floor section 1 and the wall section 2 comprise a planar heating facility which emits infrared radiation into the space 4, uniformly across its dimensions. This infrared radiation then warms at least the region of the legs and feet of the players seated on the substitutes' bench and thus prevents hypothermia in the players. The planar heating facility 3B of the wall section 2 can be seen in the rearward view of the cryoprotective device in accordance with the invention (on the right in FIG. 1), while the corresponding planar heating facility 3A of the floor section 1 is covered by the artificial turf 7 and thus discharges heat through the latter. In the plan view (at the bottom in FIG. 1), the heating facility of the floor section 1 is indicated by the reference sign 3A.

The side 8 of the wall section 2 facing forwards is tilted backwards by a slight angle, in order to present to spectators an advertising slogan attached to it from an angle which is as perpendicular as possible.

The opposing lateral peripheral regions of the floor section 1 comprise complementary interfaces 5 which are configured to establish a positive-fit connection by interlocking. As an alternative to or in addition to this, the corresponding lateral peripheral regions of the wall section 2 can also comprise such interfaces 5. The interfaces 5 enable a cryoprotective device of any length to be formed, by coupling a corresponding number of modules.

1. A cryoprotective device comprising a first section, which is a floor section (1) extending in a horizontal direction, and a second section which is a wall section (2) extending away from the floor section (1) substantially in a vertical direction, characterised by
a planar heating facility (3A) of the floor section (1) which discharges a heat output to the space (4) delineated in part by the floor section (1) and the wall section (2).

2. The cryoprotective device according to claim 1, wherein the wall section (2) also comprises a planar heating facility (3B) which discharges a heat output to the space (4) delineated in part by the floor section (1) and the wall section (2).

3. The cryoprotective device according to claim 1 or 2, wherein the heat output discharged by the planar heating facility or facilities (3A; 3B) is discharged substantially in the form of heat radiation.

4. The cryoprotective device according to any one of claims 1 to 3, wherein the planar heating facility (3A) and/or the planar heating facility (3B) comprise(s) at least one infrared radiator which emits infrared radiation in the direction of the space (4).

5. The cryoprotective device according to any one of claims 1 to 4, wherein the side (8) of the wall section (2) which faces away from the space (4) is configured to be substantially plane.

6. The cryoprotective device according to any one of claims 1 to 5, wherein the side of the floor section (1) facing the space (4) comprises a surface covering (7), in particular an artificial turf covering, which can withstand being stood on.

7. The cryoprotective device according to any one of claims 1 to 6, wherein the opposing lateral peripheral regions of the floor section (1) and/or wall section (2) of the cryoprotective device comprise(s) mutually complementary interfaces (5), by means of which the cryoprotective device can be modularly extended by coupling at least one more cryoprotective device.

8. The cryoprotective device according to any one of claims 1 to 7, which is configured as an autonomous device which can be separately transported and installed and which substantially consists of the floor section (1) and wall section (2).

9. The cryoprotective device according to any one of claims 1 to 8, wherein the floor section (1) and wall section (2) are connected to each other detachably and/or in a joint, for transport purposes.

10. The cryoprotective device according to any one of claims 1 to 9, wherein the floor section (1) comprises a region for positioning and in particular fastening a seating facility.
